(19) United States
(12) Patent Application Publication
(10) Pub. No.: US 2007/0262702 A1
(43) Pub. Date: Nov. 15, 2007

(54) Phoshor and Light-Emitting Diode

(76) Inventors: Shunsuke Fujita, Otsu-shi (JP); Setsuhisa Tanabe, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/593,872

(22) PCT Filed: Mar. 24, 2005
(86) PCT No.: PCT/JP05/05412

§ 371 Date: May 18, 2007

(30) Foreign Application Priority Data
Mar. 31, 2004 (JP) 2004-103425
Aug. 30, 2004 (JP) 2004-250079

(51) Int. Cl. H01J 1/62; C09K 11/80

(52) U.S. Cl. 313/503

(57) ABSTRACT

Phosphor 8 is attached to window portion 6 of housing vessel 7 in light-emitting diode 20. Blue excitation light 9 emitted from blue light-emitting diode chip 4 is irradiated on phosphor 8, and part of excitation light 9 is absorbed by phosphor 8, which converts its wavelength and produces yellow fluorescence 9a to be emitted outward from light-emitting diode 20. In addition, part of excitation light 9 also passes through phosphor 8 and becomes transmitted excitation light 9b, which is then emitted outward from light-emitting diode 20. Yellow fluorescence 9a and blue transmitted excitation light 9b blend to become white light 10.

### FIELD OF THE INVENTION

The present invention relates to phosphor and light-emitting diode utilizing the same.

### DESCRIPTION OF RELATED ART

Following the introduction of blue light-emitting diode (LED: light-emitting diode) in the year 1993, LEDs with the 3 primary colors of light RGB (R: red, G: green, B: blue) have been made available, and achieving white light by arranging these LEDs has been suggested. However, since the emission outputs of the three color LEDs are different, matching the characteristic of the light-emitting diode of each color to achieve white light is difficult. Even by concentrating the light-emitting diodes of the three primary colors and arranging them on a same planar surface such as when utilized as backlight for liquid crystal device, a uniform white light source could not be achieved in the case of visual verification at position near the light-emitting diodes. Moreover, the color degrading rate of the light-emitting diode of each color is different, and thus there is a problem in maintaining long-term stability of the white light.

In order to solve these problems, an LED that combines a blue LED chip and a YAG phosphor, which emits a yellow light according to a blue light beam emitted from the blue LED chip, was developed (see for example, reference 1: JP 2000-208815A). Since white light can be obtained by using one type of LED, such LED is low in cost and has an excellent long-term stability of white light. Compared to light sources for conventional lighting apparatus and the like, such white LED has the advantages such as long lifespan, high efficiency, high stability, low power consumption, and high response speed, and does not contain environmentally-unfriendly substance, and hence such kind of white LED is presently being utilized in liquid crystal device back lights of most mobile phones. Such white LED is expected to be utilized in lighting applications in future and to replace incandescent light bulb and fluorescent light as light source of the next generation.

The white LED disclosed in reference 1 has a structure in which a complex (coating member) composed of powder phosphor and resin is disposed over a light-emitting device that emits blue light. By irradiating a blue excitation light emitted from the light-emitting device onto the powder phosphor, a yellow fluorescence emitted from the phosphor is blended with the blue excitation light that passes through the resin, and the complex (coating member) composed of powder phosphor and resin emits a white light. However, in the case of long-term usage, the resin will gradually deteriorate and change color due to heat generated by the LED chip and the phosphor, or the light emitted therefrom, and this causes a decrease in emission intensity and lifespan of the white light-emitting diode.

In addition, since the complex (coating member) composed of powder phosphor and resin is fixed to cover the LED chip, the thickness of the complex (coating member) composed of powder phosphor and resin tends to vary depending on the coating conditions of the resin, thus becoming the reason for color irregularities of the emitted light. Moreover, the white LED disclosed in reference 1 requires resin for fixing the phosphor and molding member made of resin, and has a complicated structure.

### SUMMARY OF THE INVENTION

An object of the present invention is to provide a phosphor and a light-emitting diode that have a simple structure, excellent thermal resistance, light resistance and weather resistance, and can inhibit deterioration of emission intensity and shortening of lifespan of devices, such as light-emitting diode, caused by the conventional deterioration of resin.

Another object of the present invention is to provide a phosphor and a light-emitting diode that can suppress color irregularities of emitted light.

A phosphor of the present invention is composed of a single inorganic material, where when an excitation light composed of visible light is irradiated thereon, the phosphor emits a fluorescence of complimentary color with respect to a hue of the excitation light, and a portion of the excitation light transmits through the phosphor.

According to such structure, white light is emitted from the phosphor itself when an excitation light composed of visible light is irradiated on the phosphor, and thus the structure is simple with excellent thermal resistance, light resistance and weather resistance, and can inhibit deterioration of emission intensity and shortening of lifespan of devices, such as light-emitting diode, caused by conventional deterioration of resin. In other words, the phosphor emits a white light due to the blending of the excitation light transmitted through itself and the fluorescence. Further, the phosphor does not include resin, which is an organic material, and is composed of a single inorganic material with excellent thermal resistance, light resistance and weather resistance. In the case where such phosphor is utilized in devices such as light-emitting diode, since the devices are formed without using resin, coloration and deterioration of resin found in conventional light-emitting diode, due to heat generated by excitation light from the LED chip or the like and the phosphor itself, or light emitted therefrom, does not occur. As a result, the emission intensity of devices such as light-emitting diode is less prone to deterioration and lifespan of such devices become longer. Moreover, even in an ambient with severely high temperature, and even, for example, when the light-emitting diode is fixed to a housing vessel by inorganic adhesive such as metal for metallization, the light-emitting characteristic of the light-emitting diode becomes less prone to change. Furthermore, even when exposed to ultraviolet from, for example, the sunlight, coloration and deterioration due to resin will not occur because no resin is included. And even in an ambient with severely high temperature and high humidity for an extended period of time (2000 hours, 85° C. temperature and 85% humidity), light-emitting characteristic of the light-emitting diode becomes less prone to change.

When the phosphor of the present invention has a panel shape, the phosphor can be utilized as replacement material for complex composed of powder phosphor and resin in the conventional white light-emitting diode.

When the phosphor of the present invention is a panel with a large planar dimension, by installing a plurality of blue LEDs on the lower surface of such panel, such phosphor can also be utilized as component for large surface light-emitting device having both light-emitting function and diffusing function.

Furthermore, by merely employing the phosphor of the present invention as a cover glass without fixing it onto a blue light-emitting diode chip, the phosphor emits a white light and a white-light emitting diode with a simple structure can be achieved.

When the phosphor of the present invention has a panel shape, the thickness can be easily kept constant and a uniform white light can be achieved. Moreover, since the balance of the excitation light intensity and the fluorescence intensity can be varied freely by merely changing the thickness, white light with desirable chromaticity and color temperature can be achieved.

In the above described structure, it is preferable that the wall thickness of the phosphor is between 0.1 mm to 2 mm so as to achieve a desirable white light with color temperature ranging from high to low. In the case where the wall thickness is thinner than 0.1 mm, the fluorescence intensity with respect to the excitation light becomes small, the bluish hue becomes strong, and a white light is difficult to be achieved. On the contrary, when the wall thickness is thicker than 2 mm, the fluorescence intensity with respect to the excitation light becomes strong, the yellowish hue becomes strong, and a white light is difficult to be achieved. A more preferable wall thickness is between 0.1 mm to 1 mm, and further more preferably between 0.3 mm to 0.7 mm.

White light is easily achieved when the excitation light composed of visible light is a light of which center wavelength is between 430 nm to 490 nm, and the fluorescence is a light of which center wavelength is between 530 nm to 590 nm, with regard to the phosphor of the present invention.

When the phosphor of the present invention is composed of crystallized glass including Ce³⁺ and formed by precipitating garnet crystal, Ce³⁺ becomes the emission center, and the phosphor tends to absorb blue excitation light and emit yellow fluorescence while allowing part of the blue excitation light to transmit through, and thereby emits white light as the transmitted excitation light blends with the fluorescence.

Further, when the phosphor of the present invention is composed of crystallized glass formed by precipitating garnet crystal by subjecting an amorphous glass to thermal treatment, the garnet crystal disperses and remains within the matrix glass of the crystallized glass without including bubble. As a result, fluorescence and part of excitation light scatter in various directions while the phosphor itself acts as a scattering plate, and white light disperses in a wide angle. Moreover, since bubble does not exist, such as those found in complex composed of 2 or more different materials or in the interface of different materials, is present in the matrix glass or in the interface between the matrix glass and the precipitated crystal, fluorescence and excitation light that are not dispersed by the precipitated crystal are easily transmitted through, and thus increasing light-emitting efficiency.

Furthermore, when the phosphor of the present invention is composed of crystallized glass, the phosphor can be easily formed into arbitrary shapes, for example, panel shape, spherical shape, aspheric-lens shape, rod shape, cylindrical shape, fiber shape, and the like, and used according to applications.

Garnet crystal generally refers to crystals represented by A₃B₂C₃O₁₂ (A=Mg, Mn, Fe, Ca, Y, Gd, and the like; B═Al, Cr, Fe, Ga, Sc and the like; C═Al, Si, Ga, Ge and the like), and the above described garnet crystal is preferably, in particular, YAG crystal (Y₃Al₅O₁₂ crystal) or YAG crystalline solid solution, so as to emit desirable yellow fluorescence. The YAG crystalline solid solution may be a YAG crystalline solid solution in which a part of Y is replaced by at least one element selected from the group consisting of Gd, Sc, Ca and Mg, and/or a part of Al is replaced by at least one element selected from the group consisting of Ga, Si, Ge and Sc.

It is preferable that 0.01 to 5 mol % of Ce₂O₃, which serves as an emission center, is included. When the included amount of Ce₂O₃ is less than 0.01 mol %, it is difficult for the Ce₂O₃ to serve as a constituent of emission center, and the fluorescence intensity becomes insufficient. While when the included amount of Ce₂O₃ is more than 5 mol %, light-emitting efficiency will decrease due to concentration quenching, and thus such included amount is not preferable. A preferable range for the included amount of Ce₂O₃ is between 0.01 to 4 mol %, and more preferably between 0.3 to 3 mol %.

The phosphor of the present invention is preferably composed of a crystallized glass including 10 to 60 mol % of SiO₂+B₂O₃, 15 to 50 mol % of Al₂O₃+GeO₂+Ga₂O₃, 5 to 30 mol % of Y₂O₃+Gd₂O₃, 0 to 25 mol % of Li₂O, 0 to 15 mol % of TiO₂+ZrO₂, and 0.01 to 5 mol % of Ce₂O₃.

The phosphor of the present invention is more preferably composed of a crystallized glass including 10 to 50 mol % of SiO₂, 15 to 45 mol % of Al₂O₃, 5 to 30 mol % of Y₂O₃, 0 to 15 mol % of GeO₂, 0 to 20 mol % of Gd₂O₃, 0 to 15 mol % of Li₂O, 0 to 30 mol % of CaO+MgO+Sc₂O₃, and 0.01 to 5 mol % of Ce₂O₃.

Next, reasons for limiting the composition of the crystallized glass of the present invention are set forth below.

SiO₂ and B₂O₃ are oxides for forming network of the glass, and are constituents that prevent devitrification during preparation of the mother glass, and the total included amount of SiO₂ and B₂O₃ is preferably between 10 to 60 mol %. When the total amount of SiO₂ and B₂O₃ is less than 10 mol %, vitrification does not occur, and when the total included amount is more than 60 mol %, precipitation of desirable crystal becomes difficult. A preferable range for the total amount of SiO₂ and B₂O₃ is between 30 to 47 mol %. Included amount of SiO₂ is preferably between 10 to 50 mol %. When SiO₂ is less than 10 mol %, vitrification becomes difficult, and when SiO₂ is more than 50 mol %, precipitation of desirable crystal becomes difficult.

Al₂O₃, Ga₂O₃, GeO₂ are also constituents of garnet crystal and constituents that improve chemical resistance, and the total included amount of Al₂O₃, Ga₂O₃, GeO₂ is preferably between 15 to 50 mol %. When the total included amount of Al₂O₃, Ga₂O₃, GeO₂ is less than 15 mol %, precipitation of garnet crystal becomes difficult and chemical resistance decreases. While when the total included amount is more than 50 mol %, vitrification and precipitation of garnet crystal become difficult, and thus such total included amount is not preferable. A preferable range for the total amount of Al₂O₃, Ga₂O₃, GeO₂ is between 20 to 40 mol %. Included amount of Al₂O₃ is preferably between 15 to 45 mol %. When the included amount of Al₂O₃ is less than 15 mol %, precipitation of garnet crystal becomes difficult and chemical resistance is prone to decrease. While when the included amount is more than 45 mol %, vitrification becomes difficult and different type of crystal is precipitated, and thus such included amount is not preferable. In addition, GeO₂ is partly soluble in garnet crystal and has an effect of increasing the crystal precipitation amount. The included amount of GeO₂ is preferably between 0 to 15 mol %.

Y₂O₃ and Gd₂O₃ are constituents of garnet crystal, as well as constituents that improve the uniform dispersion capability of Ce and prevent concentration quenching, and the total included amount of Y₂O₃ and Gd₂O₃ is preferably between 5 to 30 mol %. When the total included amount of Y₂O₃ and Gd₂O₃ is less than 5 mol %, precipitation of garnet crystal becomes difficult, while when the total included amount is more than 30 mol %, vitrification becomes difficult, and thus such total included amounts are not preferable. A preferable range for the total amount of Y₂O₃ and Gd₂O₃ is between 10 to 25 mol %. Included amount of Y₂O₃ is preferably between 5 to 30 mol %. When the included amount of Y₂O₃ is less than 5 mol %, precipitation of garnet crystal becomes difficult, while when the included amount is more than 30 mol %, vitrification becomes difficult and different type of crystal is precipitated, and thus such included amounts are not preferable. In addition, Gd₂O₃ also has an effect of increasing the fluorescence wavelength into long wavelength and an effect of increasing the range of vitrification during the preparation of the mother glass. The included amount of Gd₂O₃ is preferably between 0 to 20 mol %. When Gd₂O₃ is more than 20 mol %, precipitation of garnet crystal becomes difficult.

Li₂O is a constituent that serves as a network modifying compound and regulates the viscosity of the glass, without coarsening the crystal size and decreasing the precipitated crystal amount, and the included amount of Li₂O is preferably between 0 to 25 mol %. When the included amount of Li₂O is more than 25 mol %, devitrification occurs in abundance during glass molding and vitrification becomes difficult, and such devitrification cannot be eliminated even by performing thermal treatment for crystallization, and thus such included amount is not preferable. Specifically, when the included amount of Li₂O is more than 2 mol %, precipitation of garnet crystal becomes easy and thus such included amount is preferable. A preferable range for the included amount of Li₂O is between 2 to 16 mol %, and a more preferable range is between 2.5 to 4.8 mol %. Further, when the included amount of Li₂O is less than 4 mol %, or when the included amount of Li₂O is more than or equal to 4 mol % while the total amount of SiO₂ and B₂O₃ is more than or equal to 40.5 mol %, completely no devitrification will be observed during glass molding and thus such amount is more preferable. When the included amount of Li₂O is more than 4 mol % and the total amount of SiO₂ and B₂O₃ is less than 40.5 mol %, slight devitrification will be observed during glass molding, but such devitrification will be eliminated by the thermal treatment for crystallization, and there is no particular problem in the precipitation of dense garnet crystal.

The total amount of ZrO₂ and TiO₂ included can be up to 15 mol %, but garnet crystal is also precipitated without including ZrO₂ and TiO₂. In actual fact, the lesser the total amount of ZrO₂ and TiO₂, for example less than 3 mol %, and more preferably including essentially no ZrO₂ and TiO₂, the higher the light-emitting efficiency becomes and thus such total amount is preferable. When the total included amount of ZrO₂ and TiO₂ is more than 15 mol %, precipitation of desirable crystal becomes difficult and thus such total included amount is not preferable. Here, “including essentially no ZrO₂ and TiO₂” refers to the case where ZrO₂ and TiO₂ are completely not included, and also the case where the included amount of ZrO₂ and TiO₂ is a small amount of 0.1 mol % or less.

CaO, MgO and Sc₂O₃ are constituents that are solid soluble in garnet crystal and can regulate the emission wavelength of Ce. The total amount of CaO, MgO and Sc₂O₃ included is preferably between 0 to 30 mol %, as devitrification occurs when the total amount thereof is more than 30 mol %.

Apart from the above described constituents, Na₂O, CaO, MgO, K₂O and the like can also be added independently or in combination with a total amount of up to 15 mol %.

Further, since the light-emitting diode of the present invention is made by utilizing a phosphor with the above described structure, when excitation light composed of visible light is irradiated thereon, white light produced by the blending of the transmitted excitation light and the fluorescence is emitted. Moreover, since the phosphor is composed of a single inorganic material with excellent thermal resistance, light resistance and weather resistance, and does not include resin, which is an organic material, and also can be fixed without using resin, coloration and deterioration of resin found in conventional light-emitting diode, due to heat generated by excitation light from the LED chip or the like and the phosphor, or light emitted therefrom, does not occur. As a result, emission intensity is not prone to deterioration, long-term stability of the color of the white light is excellent, and lifespan increases.

In addition, since the crystallized glass of the present invention includes Ce³⁺ and is formed by precipitating garnet crystal, Ce³⁺ becomes the emission center, and the crystallized glass becomes a phosphor that absorbs blue excitation light and emits yellow fluorescence while allowing part of the blue excitation light to transmit through, and thereby emits white light as the transmitted excitation light blends with the fluorescence.

The crystallized glass of the present invention is formed by precipitating garnet crystal by subjecting an amorphous glass to thermal treatment, and the garnet crystal disperses and remains within the matrix glass of the crystallized glass without including bubble. Therefore, when the crystallized glass of the present invention is utilized as a phosphor, fluorescence and part of excitation light scatter in various directions while the phosphor itself acts as a scattering plate, and white light disperses in a wide angle. Moreover, since bubble does not exist, such as those found in complex composed of 2 or more different materials or in the interface of different materials, is present in the matrix glass or in the interface between the matrix glass and the precipitated crystal, fluorescence and excitation light that are not dispersed by the precipitated crystal are easily transmitted through, and thus increasing light-emitting efficiency.

The crystallized glass of the present invention is melted such that it becomes the above described composition, and crystallizable glass with arbitrary shapes, for example, panel shape, spherical shape, aspheric-lens shape, rod shape, cylindrical shape, fiber shape, and the like, can be fabricated by typical glass panel forming method such as roll forming, cutout from casting, slot-down forming, overflow forming, down-draw forming, danner forming, and redraw forming. Thereafter, when the crystallizable glass is subjected to thermal treatment at between 1150 to 1600° C., and preferably between 1200 and 1500° C., for 0.5 to 20 hours, YAG crystal or YAG crystalline solid solution can be precipitated and thus is preferable. In addition, the glass may also be processed into desirable shapes after crystallization.

### BRIEF DESCRIPTION OF DRAWINGS

FIG. 1 is a cross-sectional view representing a light-emitting diode related to an embodiment.

FIG. 2 is a graph representing reflection fluorescence spectra of example 1 and comparative example 1.

FIG. 3 is a graph representing transmitted light spectra of example 1 and example 9.

FIG. 4 is a diagram representing chromaticity of transmitted light when wall thickness is varied from 0.2 mm to 1.0 mm, with regard to example 13.

### DETAILED DESCRIPTION OF PREFERRED EMBODIMENTS

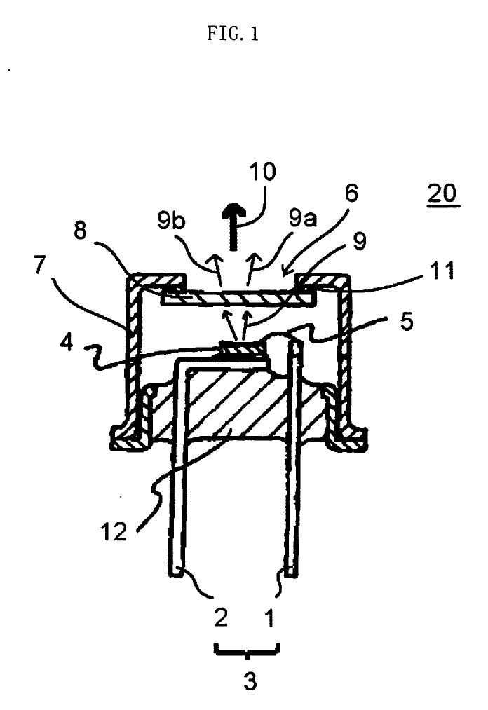

A light-emitting diode 20 related to an embodiment includes, for example as illustrated in FIG. 1, a stem 3 including a cathode lead terminal 1 and an anode lead terminal 2, a blue light-emitting diode chip 4 connected to the anode lead terminal 2, a metal wire 5 connecting the cathode lead terminal 1 and the blue light-emitting diode chip 4, a housing vessel 7 that is fixed such that the stem 3 and the blue light-emitting diode chip are air-tightly sealed, and of which a window portion 6 is formed above the blue light-emitting diode chip, and a phosphor 8 attached to the window portion 6 of the housing vessel 7. Therefore, the window portion 6 not only functions as a cover glass but can also function as a phosphor. In other words, a blue excitation light 9 emitted from the blue light-emitting diode chip 4 is irradiated on the phosphor 8, and part of the excitation light 9 is absorbed by the phosphor 8, which converts its wavelength, and a yellow fluorescence 9a is emitted outward from the light-emitting diode 20. In addition, part of the excitation light 9 also passes through the phosphor 8 and becomes a transmitted excitation light 9b, which is then emitted outward from the light-emitting diode 20. The yellow fluorescence 9a and the blue transmitted excitation light 9b blend to become a white light 10.

Further, although the phosphor 8 is fixed to the metal housing vessel 7 by an adhesive 11, the adhesive 11 does not deteriorate easily even if it is made of resin because the excitation light 9 does not come in direct contact with the adhesive 11, and hence even if the phosphor 8 generates heat and the color of the adhesive 11 changes, the fluorescence 9a and the transmitted excitation light 9b will not be adversely affected. In the case where the adhesive 11 is composed of a glass with low melting point, even if the phosphor 8 generates heat, the adhesive 11 will not deteriorate, and thus it is preferable for the adhesive 11 to be composed of a glass with low melting point. Moreover, although the stem 3 and the housing vessel 7 can be air-tightly sealed by a sealant 12 composed of resin or glass with low melting point, deterioration of the sealant 12 decreases and reliability increases when the stem 3 and the housing vessel 7 are air-tightly sealed by the sealant 12 composed, particularly, of glass with low melting point, and thus it is preferable for the sealant 12 to be composed, particularly, of glass with low melting point. In the case where the wall thickness of the phosphor 8 is between 0.1 to 2 mm, excitation light can easily pass through and a desirable white light with color temperature ranging from high to low can be achieved, and thus such wall thickness is preferable. A preferable range for the wall thickness is between 0.2 to 1 mm. Furthermore, it is preferable that the edges of the phosphor 8 are beveled to suppress chipping.

### EXAMPLES

Hereinafter, the examples will be described.

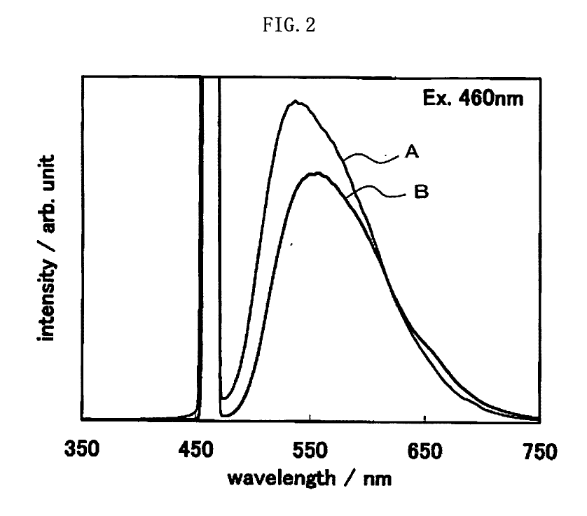

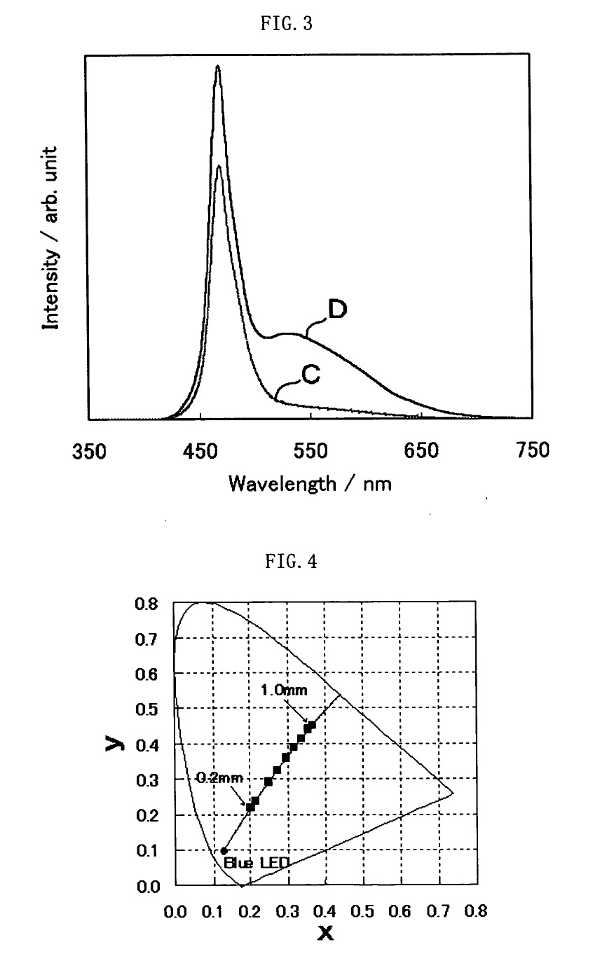

Table 1 represents examples 1 to 8, table 2 represents examples 9 to 16, table 3 represents examples 17 to 24, and table 4 represents comparative examples 1 to 3 of the present invention. FIG. 2 is a graph representing the fluorescence spectra of the example 1 and a commercially available Ce:YAG phosphor (powder) when excitation light is reflected from sample surfaces. FIG. 3 is a graph representing the transmitted light spectra of examples 1 and 9 when excitation light is being transmitted. FIG. 4 is a diagram representing the chromaticity of transmitted light when wall thickness is varied from 0.2 mm to 1.0 mm, with regard to example 13.

TABLE 1

| | Mol % | | | | | | | |
|---|---|---|---|---|---|---|---|---|
| | Eg 1 | Eg 2 | Eg 3 | Eg 4 | Eg 5 | Eg 6 | Eg 7 | Eg 8 |
| SiO₂ | 36.0 | 31.2 | 42.9 | 40.4 | 44.1 | 40.4 | 36.7 | 46.3 |
| B₂O₃ | 0.0 | 6.2 | 0.0 | 0.0 | 0.0 | 5.2 | 0.0 | 0.0 |
| Al₂O₃ | 30.9 | 17.8 | 22.1 | 19.4 | 22.6 | 15.3 | 34.0 | 28.4 |
| Ga₂O₃ | 0.0 | 12.2 | 0.0 | 0.0 | 0.0 | 7.3 | 0.0 | 0.0 |
| Y₂O₃ | 18.1 | 12.2 | 20.1 | 24.4 | 13.6 | 9.7 | 14.9 | 12.4 |
| Gd₂O₃ | 0.0 | 5.2 | 0.0 | 0.0 | 0.0 | 3.6 | 0.0 | 0.0 |
| Li₂O | 9.6 | 9.3 | 9.6 | 10.1 | 15.1 | 13.3 | 9.2 | 7.7 |
| TiO₂ | 3.0 | 3.2 | 3.0 | 3.2 | 2.5 | 0.0 | 2.8 | 2.8 |
| ZrO₂ | 1.9 | 2.2 | 1.9 | 2.0 | 1.7 | 4.8 | 1.9 | 1.9 |
| Ce₂O₃ | 0.5 | 0.5 | 0.4 | 0.5 | 0.4 | 0.4 | 0.5 | 0.5 |
| Vitrification | Δ | Δ | ◯ | Δ | ◯ | ◯ | Δ | ◯ |
| Crystallization | 1500° C. | 1400° C. | 1450° C. | 1450° C. | 1450° C. | 1450° C. | 1400° C. | 1400° C. |
| Temperature | | | | | | | | |
| Precipitated | YAG | YAG | YAG | YAG | YAG | YAG | YAG | YAG |
| Crystal | | s.s. | | | | s.s. | | |
| Light-emitting | ◯ | ◯ | ◯ | ◯ | ◯ | ◯ | ◯ | ◯ |
| Characteristic | | | | | | | | |

* Eg = Example

TABLE 2

| | Eg 9 | Eg 10 | Eg 11 | Eg 12 | Eg 13 | Eg 14 | Eg 15 | Eg 16 |
|---|---|---|---|---|---|---|---|---|
| SiO₂ | 40.9 | 40.1 | 35.8 | 38.9 | 42.3 | 35.1 | 45.9 | 42.3 |
| B₂O₃ | 0.0 | 0.0 | 0.0 | 2.0 | 0.0 | 5.0 | 0.0 | 0.0 |
| Al₂O₃ | 35.0 | 34.3 | 30.7 | 35.0 | 34.2 | 34.3 | 23.6 | 34.2 |
| Y₂O₃ | 20.6 | 20.1 | 18.0 | 20.6 | 20.0 | 20.1 | 14.2 | 11.9 |
| Gd₂O₃ | 0.0 | 0.0 | 0.0 | 0.0 | 0.0 | 0.0 | 0.0 | 8.2 |
| Li₂O | 3.0 | 5.0 | 15.0 | 3.0 | 3.0 | 5.0 | 15.8 | 3.0 |
| Ce₂O₃ | 0.5 | 0.5 | 0.5 | 0.5 | 0.5 | 0.5 | 0.5 | 0.5 |
| Vitrification | ◯ | Δ | Δ | ◯ | ◯ | Δ | ◯ | ◯ |
| Crystallization | 1400° C. | 1450° C. | 1450° C. | 1400° C. | 1400° C. | 1450° C. | 1400° C. | 1380° C. |
| Temperature | | | | | | | | |
| Precipitated | YAG | YAG | YAG | YAG | YAG | YAG | YAG | YAG |
| Crystal | | | | | | | | s.s. |
| Light-emitting | ◯ | ◯ | ◯ | ◯ | ◯ | ◯ | ◯ | ◯ |
| Characteristic | | | | | | | | |

* Eg = Example

TABLE 3

| | Mol % | | | | | | | |
|---|---|---|---|---|---|---|---|---|
| | Eg 17 | Eg 18 | Eg 19 | Eg 20 | Eg 21 | Eg 22 | Eg 23 | Eg 24 |
| SiO₂ | 42.3 | 43.6 | 33.7 | 34.6 | 33.8 | 39.3 | 33.8 | 33.8 |
| B₂O₃ | 0.0 | 0.0 | 7.9 | 0.0 | 0.0 | 0.0 | 0.0 | 0.0 |
| Al₂O₃ | 34.2 | 29.7 | 34.6 | 35.5 | 35.7 | 34.2 | 33.7 | 33.7 |
| GeO₂ | 0.0 | 0.0 | 0.0 | 5.4 | 6.0 | 0.0 | 6.0 | 4.6 |
| Y₂O₃ | 7.8 | 23.1 | 20.3 | 20.8 | 12.4 | 20.0 | 10.4 | 10.4 |
| Gd₂O₃ | 12.2 | 0.0 | 0.0 | 0.0 | 8.5 | 0.0 | 8.5 | 8.5 |
| Li₂O | 3.0 | 3.1 | 3.0 | 3.1 | 3.1 | 3.0 | 3.1 | 3.1 |
| CaO | 0.0 | 0.0 | 0.0 | 0.0 | 0.0 | 3.0 | 2.0 | 1.4 |
| MgO | 0.0 | 0.0 | 0.0 | 0.0 | 0.0 | 0.0 | 0.0 | 2.0 |
| Sc₂O₃ | 0.0 | 0.0 | 0.0 | 0.0 | 0.0 | 0.0 | 2.0 | 2.0 |
| Ce₂O₃ | 0.5 | 0.5 | 0.5 | 0.5 | 0.5 | 0.5 | 0.5 | 0.5 |
| Vitrification | ◯ | ◯ | ◯ | ◯ | ◯ | ◯ | ◯ | ◯ |
| Crystallization | 1380° C. | 1380° C. | 1380° C. | 1440° C. | 1430° C. | 1450° C. | 1450° C. | 1450° C. |
| Temperature | | | | | | | | |
| Precipitated | YAG | YAG | YAG | YAG | YAG | YAG | YAG | YAG |
| Crystal | s.s. | | | | s.s. | | s.s. | s.s. |
| Light-emitting | ◯ | ◯ | ◯ | ◯ | ◯ | ◯ | ◯ | ◯ |
| Characteristic | | | | | | | | |

* Eg = Example

TABLE 4

| | C.E 1 | C.E 2 | C.E 3 |
|---|---|---|---|
| SiO₂ | 58.0 | 36.0 | 38.9 |
| B₂O₃ | 4.3 | 0.0 | 2.0 |
| Al₂O₃ | 14.8 | 30.9 | 35.0 |
| Ga₂O₃ | 0.0 | 0.0 | 0.0 |
| Y₂O₃ | 12.2 | 18.1 | 20.6 |
| Gd₂O₃ | 0.0 | 0.0 | 0.0 |
| Li₂O | 7.5 | 9.6 | 3.0 |
| TiO₂ | 1.5 | 3.0 | 0.0 |
| ZrO₂ | 1.2 | 1.9 | 0.0 |
| Ce₂O₃ | 0.5 | 0.5 | 0.5 |
| Vitrification | ◯ | Δ | ◯ |
| Crystallization | 1400° C. | — | — |
| Temperature | | | |
| Precipitated | Different | — | — |
| Crystal | Crystal | | |
| Light-emitting | X | X | X |
| Characteristic | | | |

* C.E = Comparative Example

Crystallized glasses of the examples and the comparative examples were fabricated as follows.

First, glass law materials, being prepared into compositions represented in Tables 1 to 4, were introduced into a platinum crucible and melted at 1650° C. for 3 hours, and thereafter, crystallizable glasses were obtained by introducing the molten glass material onto a carbon panel. These crystalline glasses were then subjected to thermal treatment for 5 to 20 hours at the thermal treatment temperatures shown in Tables 1 to 4 to obtain the crystallized glasses of examples 1 to 24 and comparative example 1. With regard to examples 1, 2, 4, 7, 10, 11 and 14, although slight devitrification was observed during glass molding, such devitrification was eliminated by the thermal treatment for crystallization, and dense garnet crystals were precipitated. Comparative example 2 was the crystallizable glass of example 1 and comparative example 3 was the crystallizable glass of example 12, and both were not subjected to thermal treatment.

As shown in Tables 1 and 2, YAG crystals were precipitated in examples 1, 3-5, 7-15, 18-20 and 22, while YAG crystalline solid solutions were precipitated in examples 2, 6, 16, 17, 21, 23 and 24. Further, as shown in FIG. 2, a fluorescence spectrum (A) having a yellow fluorescence with a center wavelength that peaked at 540 nm and a blue excitation light with a center wavelength that peaked at 460 nm was detected in example 1 during reflection fluorescence spectrum determination. A white light emitting from a surface opposite to the excitation light incidence plane of a panel sample was also observed with the unaided eye. Further, the reflection fluorescence intensity of example 1 was higher than the fluorescence intensity of a fluorescence spectrum (B) of a commercially available powder phosphor (P46-Y3 produced by Kasei Optonix, Ltd.) and displayed sufficient fluorescence intensity. Reflection fluorescence spectrum same as that of example 1 can also be achieved in examples 2 to 15. As shown in FIG. 3, a blue excitation light spectrum that peaked at 460 nm, and a yellow fluorescence spectrum of which wavelength was converted and peaked at 540 nm were observed in example 1 (C) and example 9 (D), and these spectrum intensities were high particularly in example 9 (D), in which no TiO₂and ZrO₂were included. With regard to example 13, after 1 hour of thermal treatment at 800° C., the emission intensity after thermal treatment was 95% or more with respect to the emission intensity before thermal treatment, thus displaying excellent thermal resistance. Moreover, with regard to example 13, the emission intensity after a 2000 hours treatment in an ambient with 85° C. temperature and 85% humidity was 97% or more with respect to the emission intensity before such treatment, thus displaying excellent weather resistance.

As shown in FIG. 4, as the wall thickness of crystallized glass was varied from 0.2 to 1.0 mm, and the chromaticity of the light that passed through such crystallized glass was measured with an integrating sphere and calculated by an analysis software, a white light with a blue tinge (x value and y value were small) was emitted in the case where the wall thickness was thin, while a white light with a yellow tinge (x value and y value were large) was emitted as the wall thickness increased. Therefore, it was made known that desirable white light can be achieved by varying the wall thickness of crystallized glass.

On the other hand, with regard to comparative example 1, although vitrification occurred, the precipitated crystal was a different type of crystal (yttrium silicate) from YAG crystal, and hence the fluorescence intensity was low, and the center wavelength (450 nm) of the fluorescence was in a wavelength region shorter than 540 nm, and a yellow fluorescence could not be observed. Furthermore, comparative examples 2 and 3 included no YAG crystal and hence completely no fluorescence was emitted.

The precipitated crystal types were identified by powder X-ray diffractometry.

The reflection fluorescence characteristic (spectrum) was determined using a standard fluorescence spectrum measuring device, and by irradiating a light with 460 nm excitation wavelength onto one side of a sample, and then detecting the light emitted from that side using a detector. With regard to the determination of fluorescence spectrum, example 1 utilized a fabricated crystallized glass panel processed to 20×20×0.5 mm as the sample. In the case of commercially available powder phosphor, a pressed molded panel with 1 mm of thickness was utilized as a measuring sample.

The transmitted light spectrum was determined by irradiating a light with 460 nm excitation wavelength onto one side of a sample, and then measuring the light emitted from the surface on the opposite side of said side using a standard fluorescence spectrum measuring device. The sample thickness was 0.4 mm.

With regard to the vitrification in tables 1 to 3, “◯” represents a homogeneous glass with no devitrification during molding were obtained, and “Δ” represents a slight devitrification during molding. Further, in tables 1 to 3, “YAG” represents that the precipitated crystal was YAG crystal, “YAG s.s.” represents that the precipitated crystal was YAG crystalline solid solution, and “Different Crystal” represents types of crystal apart from YAG crystal and YAG crystalline solid solution. With regard to light-emitting characteristic, “◯” represents the case where fluorescence spectrum with 530 to 590 nm of center wavelength were achieved while “×” represents otherwise.

### POSSIBILITY OF INDUSTRIAL USED

As described above, the phosphor of the present invention itself emits white light by combining with blue LED, particularly, when irradiated with excitation light composed of visible light, and hence has a simple structure with excellent thermal resistance, light resistance and weather resistance, and can inhibit deterioration of emission intensity and shortening of lifespan of devices, such as light-emitting diode, caused by deterioration or resin. As a result, the phosphor of the present invention is suitable to be used as replacement material for complex (coating member) composed of powder phosphor and resin, in white light-emitting diode utilized in backlights for lighting apparatuses, vehicles, display boards, liquid crystal devices and the like, or as component for large surface light-emitting device having both light emitting function and diffusing function.

1. A phosphor composed of a single inorganic material, wherein when an excitation light composed of visible light is irradiated thereon, the phosphor emits a fluorescence of complimentary color with respect to a hue of the excitation light, and a portion of the excitation light transmits through the phosphor.

2. The phosphor according to claim 1 having a panel shape.

3. The phosphor according to claim 2 of which a wall thickness is between 0.1 mm to 2 mm.

4. The phosphor according to claim 1, wherein the excitation light composed of visible light is a light of which center wavelength is between 430 to 490 nm, and the fluorescence is a light of which center wavelength is between 530 to 590 nm.

5. The phosphor according to claim 1 composed of a crystallized glass including Ce³⁺ and formed by precipitating a garnet crystal.

6. The phosphor according to claim 5, wherein the garnet crystal is YAG crystal or YAG crystalline solid solution.

7. The phosphor according to claim 5 including 0.01 to 5 mol % of Ce₂O₃.

8. The phosphor according to claim 1 composed of a crystallized glass including 10 to 60 mol % of SiO₂+B₂O₃, 15 to 50 mol % of Al₂O₃+GeO₂+Ga₂O₃, 5 to 30 mol % of Y₂O₃+Gd₂O₃, 0 to 25 mol % of Li₂O, 0 to 15 mol % of TiO₂+ZrO₂, and 0.01 to 5 mol % of Ce₂O₃.

9. The phosphor according to claim 8 including essentially no TiO₂ and ZrO₂.

10. The phosphor according to claim 1 composed of a crystallized glass including 10 to 50 mol % of SiO₂, 15 to 45 mol % of Al₂O₃, 5 to 30 mol % of Y₂O₃, 0 to 15 mol % of GeO₂, 0 to 20 mol % of Gd₂O₃, 0 to 15 mol % of Li₂O, 0 to 30 mol % of CaO+MgO+Sc₂O₃, and 0.01 to 5 mol % of Ce₂O₃.

11. A light-emitting diode utilizing the phosphor according to claim 1.

12. A light-emitting diode comprising:
a stem including a cathode lead terminal and an anode lead terminal,
a light-emitting diode chip connected to the anode lead terminal,
a metal wire connecting the cathode lead terminal and the light-emitting diode chip,
a housing vessel that is fixed such that the stem and the light-emitting diode chip are air-tightly sealed, and of which a window portion is formed above the light-emitting diode chip, and
the phosphor according to claim 1 attached to the window portion of the housing vessel.

13. A crystallized glass including Ce³⁺ and formed by precipitating a garnet crystal.

14. The crystallized glass according to claim 13, wherein the garnet crystal is YAG crystal or YAG crystalline solid solution.

15. The crystallized glass according to claim 13 including 0.01 to 5 mol % of Ce₂O₃.

16. The crystallized glass according to claim 13 including 10 to 60 mol % of SiO₂+B₂O₃, 15 to 50 mol % of Al₂O₃+GeO₂+Ga₂O₃, 5 to 30 mol % of Y₂O₃+Gd₂O₃, 0 to 25 mol % of Li₂O, 0 to 15 mol % of TiO₂+ZrO₂, and 0.01 to 5 mol % of Ce₂O₃.

17. The crystallized glass according to claim 16 including essentially no TiO₂ and ZrO₂.

18. The crystallized glass according to claim 13 including 10 to 50 mol % of SiO₂, 15 to 45 mol % of Al₂O₃, 5 to 30 mol % of Y₂O₃, 0 to 15 mol % of GeO₂, 0 to 20 mol % of Gd₂O₃, 0 to 15 mol % of Li₂O, 0 to 30 mol % of CaO+MgO+Sc₂O₃, and 0.01 to 5 mol % of Ce₂O₃.
